(19) United States
(12) Patent Application Publication
(10) Pub. No.: US 2018/0282594 A1
(43) Pub. Date: Oct. 4, 2018

(54) NON-HALOGEN FLAME RETARDANT ADHESIVE COMPOSITION AND TAPE COMPRISING SAME

(71) Applicant: 3M Innovative Properties Company, St. Paul, MN (US)

(72) Inventors: Sung-Tso Lin, Taoyuan City (TW); Wei-Cheng Su, Taoyuan City (TW)

(73) Assignee: 3M Innovative Properties Company, St. Paul, MN (US)

(21) Appl. No.: 15/762,298

(22) PCT Filed: Oct. 15, 2015
(86) PCT No.: PCT/CN2015/091994

§ 371 Date: Mar. 22, 2018

(51) Int. Cl. C09J 11/06; C08K 5/523; C08K 5/3492; C08K 3/32; C09J 11/04; C09J 9/00; C09J 7/38

(52) U.S. Cl. CPC C09J 11/06; C09J 2433/00; C08K 5/34924; C08K 5/34922; C08K 3/32; C09J 11/04; C09J 9/00; C09J 7/385; C08K 2003/321; C08K 2003/329; C09J 2203/326; C09J 2205/102; C09J 2467/006; C09J 2400/263; C08K 5/523

(57) ABSTRACT

A non-halogen flame retardant adhesive composition and tape comprises the same are disclosed. The non-halogen flame retardant adhesive composition comprises an adhesive and a flame retardant composition. The flame retardant composition comprises a phosphoric acid ester compound and a flame retardant material selected from one or more elements of a group consisting of melamine cyanurate, melamine pyrophosphate and phosphinate salt. The ratio of the adhesive and the flame retardant composition is in a range from 1:0.7 to 1:1.2, and the non-halogen flame retardant adhesive composition has 180 degree peeling strength above 1.0 kg/in based on ASTM-D3330 and achieves a UL 94 VTM flame resistance capability.

### BACKGROUND

For safety concern, the materials for wrapping power cords of electronic devices or electronic equipments, or the coating for printed circuit boards, are added with flame retardant reagents for providing flame retardant effect. For assembling the parts of electronic devices and/or equipments, adhesives are widely applied. Similarly, for safety, the adhesives used in electronic field have to be flame retardant. The most widely known and used flame retardant adhesives utilize one or more halogen-containing compounds. However, there is environmental and safety issue for using material with halogen-containing compounds. To overcome such issue, some technologies in associated with using non-halogen materials for adhesives are developed. Current available non-halogenated or halogen free adhesives fail to demonstrate high level of flame resistance capability. In addition, when the thickness of adhesive material decreased, the adhesion will be affected.

### SUMMARY

In the current invention, a non-halogen flame retardant adhesive composition is provided, wherein the adhesion and flame retardant capability can be kept when producing thin adhesive tapes with the non-halogen flame retardant adhesive provided in the current invention. The non-halogen flame retardant adhesive composition comprises an adhesive and a flame retardant composition. The flame retardant composition comprises a phosphoric acid ester compound and a flame retardant material selected from one or more elements of a group consisting of melamine cyanurate, melamine pyrophosphate and phosphinate salt. The ratio of the adhesive and the flame retardant composition is in a range from 1:0.7 to 1:1.2, and the non-halogen flame retardant adhesive composition has 180 degree peeling strength above 1.0 kg/in based on ASTM-D3330 and achieves a UL 94 VTM flame resistance capability.

An adhesive tape is also provided in the current invention, wherein the adhesive tape comprises a backing and a non-halogen flame retardant adhesive coated thereon. The non-halogen flame retardant adhesive composition comprises an adhesive and a flame retardant composition. The flame retardant composition comprises a phosphoric acid ester compound and a flame retardant material selected from one or more elements of a group consisting of melamine cyanurate, melamine pyrophosphate and phosphinate salt. The ratio of the adhesive and the flame retardant composition is in a range from 1:0.7 to 1:1.2, and adhesive tape made by the non-halogen flame retardant adhesive composition has 180 degree peeling strength above 1.0 kg/in based on ASTM-D3330 and achieves a UL 94 VTM flame resistance capability.

### DETAILED DESCRIPTION

Unless otherwise indicated, all numbers expressing feature sizes, amounts, and physical properties used in the specification and claims are to be understood as being modified in all instances by the terms “about” or “substantially”. Unless indicated to the contrary, the numerical parameters set forth in the specification and attached claims are approximations that can vary depending upon the desired properties sought to be obtained by those skilled in the art utilizing the teachings disclosed herein. The use of numerical ranges by endpoints includes all numbers within that range (e.g., 0.7 to 1.2 includes 0.70, 0.75, 0.80, 0.85, 0.90, 0.95, 1.00, 1.05, 1.10, 1.15, and 1.20) and any range within that range.

This invention is related to a non-halogen flame retardant adhesive composition. “Non-halogen” used herein refers to the substantial absence, e.g., trace or ineffective amounts, of halogens, i.e., fluorine, chlorine, bromine, iodine, and astatine. The non-halogen flame retardant adhesive composition comprises an adhesive and a flame retardant composition, and the flame retardant composition comprises a phosphoric acid ester compound and a flame retardant powder. The flame retardant material is selected from one or more elements of a group consisting of melamine cyanurate, melamine pyrophosphate and phosphinate salt. The ratio of adhesive and flame retardant composition is in a range from 1:0.7 to 1:1.2 (W/W), and the non-halogen flame retardant adhesive composition has 180 degree peeling strength substantially above 1.0 kg/in based on ASTM-D3330 and achieves a UL 94 VTM flame resistance capability, for example, achieved UL94 VTM 2, UL94 VTM 1, or in some cases achieved UL94 VTM 0 flame resistance capability.

The adhesive that can be applied in the present invention is not limited. As is well known in the art, adhesives may be grouped as acrylic adhesives, polyolefin adhesives, styrenic co-polymer adhesives, silicone adhesives, epoxy adhesives, ethylene co-polymer adhesives, and other types of adhesives. When described by their adhesion properties, adhesives of the present invention may be grouped as pressure sensitive adhesives, thermoset adhesives, hot-melt adhesives, and other types of adhesives. In a preferred embodiment, the adhesive is acrylic-based pressure sensitive adhesives.

The flame retardant composition of the current invention comprises a phosphoric acid ester compound and a flame retardant powder. In one embodiment, the phosphoric acid ester is bis-phenol A bis (diphenyl phosphate) represented by structure below. In a preferred embodiment, n is 1 or 2.

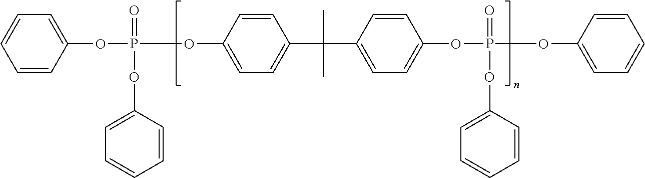

The flame retardant material may comprise one or more elements. The elements are selected from a group consisting of powder of melamine cyanurate, powder of melamine pyrophosphate, powder of phosphinate salt, or the combination thereof. The melamine cyanurate is represented by:

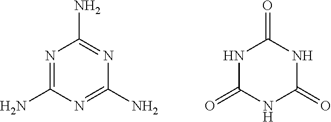 [SMILES: Nc1nc(N)nc(N)n1 ; O=c1[nH]c(=O)[nH]c(=O)[nH]1]

The melamine Pyrophosphate of the current invention is represented by:

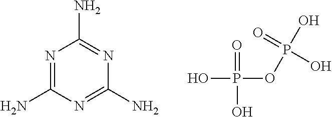 [SMILES: Nc1nc(N)nc(N)n1 ; O=P(O)(O)OP(=O)(O)O]

The phosphinate salt in the current invention is represented by structure below, wherein M is magnesium, calcium, aluminum or zinc; m is 3 or 2; and R1, R2 may be identical or different, which can be C1-C6-alkyl, linear or branched, and/or aryl. In some embodiments, phosphinate salt can be aluminum phosphinate salt like aluminum diethylphosphinate, but not limited thereto.

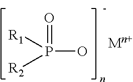

In some embodiments, the ratio(W/W) of adhesive and flame retardant composition is in a range from 1:0.7 to 1:1.2, for example: 1:0.7, 1:0.8, 1:0.9, 1:1.0, 1:1.1 or 1:1.2. Of course, it can be any ratio in this range. Flame retardant composition comprises phosphoric acid ester compound and a flame retardant material. When the ration (W/W) of adhesive and flame retardant material is about 1:0.7, the ratio of phosphoric acid ester compound and a flame retardant material is substantially no larger than 2:5, for example, the ratio of phosphoric acid ester compound and a flame retardant material may be 1:6 or 2:5. When the ration (W/W) of adhesive and flame retardant material is raised to 1:1.2, the ratio of phosphoric acid ester compound and a flame retardant material is substantially no larger than 5:7, for example: the ratio of phosphoric acid ester compound and a flame retardant material may be 1:11, 2:10, 3:9, 4:8, or 5:7. In other words, the ratio of phosphoric acid ester compound to the total flame retardant composition is no larger than 41.6%. But it is to be understood that the ratio of phosphoric acid ester compound to the total flame retardant composition can be any value less than 41.6%. For example, phosphoric acid ester compound is equal to or less than 33.3% of the flame retardant composition, or equal to or less than 28.6% of the flame retardant composition. In some embodiments, the phosphoric acid ester compound can be 25.0%, 16.7%, 14.3%, or 8.3% of total flame retardant composition; in some other embodiments, the ratio of phosphoric acid ester compound to the total flame retardant composition is in the range of 8.3%˜25.0%, wherein the phosphoric acid ester compound is bis-phenol A bis (diphenyl phosphate).

As the flame retardant material of the flame retardant composition, it can be powders selected from melamine Cyanurate, melamine pyrophosphate, phosphinate salt or the combination thereof. When the flame retardant material of the flame retardant composition comprises two elements, the ratio of these two elements can be equal (1:1). When the flame retardant material of the flame retardant composition comprises three elements, the ratios of melamine cyanurate and melamine pyrophosphate are substantially equal, and the ratio of melamine cyanurate or melamine pyrophosphate to phosphinate salt is in a range from 1:1 to 1:4. In other words, the ratio of melamine cyanurate, melamine pyrophosphate, and phosphinate salt may be, for example, 1:1:1, 1:1:2, 1:1:3, or 1:1:4.

The non-halogen flame retardant adhesive composition can be applied to some film backing material for fabricating adhesive tapes. In some embodiments, the backing can be tissue or polyester like polyethylene terephthalate (PET). Tissue backing generally refers to natural fibers like animal fibers or vegetable fibers, or artificial fibers. The average thickness of the backing is substantially less than or equal to 160 um, preferably to be in a range of 25˜45 um. However, since the thickness of backing may be difference due to manufacturing process, it is to be understood that the thickness of backing in the present invention refers to an average thickness, and there may have a 10 um tolerance. In addition, the selection of backing thickness can be adjusted base on the thickness requirement of adhesive tapes. As the coating thickness of non-halogen flame retardant adhesive composition, it is in a range from 25-75 um, for example, 50 um. When coating on both sides of the backing to make double coated adhesive tapes, the coating thickness on each side is also in a range of 25-75 um.

### EXAMPLES

The following examples and comparative examples are offered to aid in the understanding of the present invention. Such examples and comparative examples are not to be construed as limiting the scope thereof. Unless otherwise indicated, all parts and percentages are by weight. The following test methods and protocols were employed in the evaluation of the illustrative and comparative examples that follow:

Test Methodologies

1. UL94 VTM Flammability Test:

The flame retardancy rating test was carried out according to the test standard of UL94 VTM (standard published by U.S. Underwriters' Laboratories Inc.). The UL94 VTM test procedure is as follows: constructing 8 inch long by 0.5 inch diameter tube from each sample, marking the tube 5 inches from the bottom, applying flame to the base of tube suspended in a test chamber for 3 seconds, withdrawing flame and recording combustion time (after-flame time t1), reapplying the flame to the same sample again for 3 seconds, and withdrawing and recording combustion time (after-flame time t2) and glow time (after-glow time t3). Each test is comprised of 5 specimens.

UL94 VTM-0: after-flame time for each individual specimen t1 or t2 is less than 10 s; total after-flame time for any condition set (t1 plus t2 for the 5 specimens) is less than 50 s; after-flame time plus after-glow time for each individual specimen after the second flame application (t2 plus t3 for the 5 specimens) is less than 30 s; no after-flame or afterglow of any specimen is up to the 5 inch mark; and no cotton indicator is ignited by flaming particles or drops.

UL94 VTM-1: after-flame time for each individual specimen t1 or t2 is less than 30 s; total after-flame time for any condition set (t1 plus t2 for the 5 specimens) is less than 250 s; after-flame time plus after-glow time for each individual specimen after the second flame application (t2 plus t3 for the 5 specimens) is less than 60 s; no after-flame or afterglow of any specimen is up to the 5 inch mark; and no cotton indicator is ignited by flaming particles or drops.

UL94 VTM-2: after-flame time for each individual specimen t1 or t2 is less than 30 s; total after-flame time for any condition set (t1 plus t2 for the 5 specimens) is less than 250 s; after-flame time plus after-glow time for each individual specimen after the second flame application (t2 plus t3 for the 5 specimens) is less than 60 s; no after-flame or afterglow of any specimen is up to the 5 inch mark; and allow cotton indicator ignited by flaming particles or drops.

2. Adhesive Strength Test:

The testing method was the 180 degree peeling strength based on ASTM-D3330. The test environment condition is controlled as 23+/−2° C. and 65+/−5% relative humidity (RH). Each of samples was obtained from each resulting sheets cut in 25 mm wide and 200 mm long. Each of samples was attached to a stainless steel (SUS304) plate. Samples were compressed with a rubber roller with 2 kg load (rubber hardness: 75 to 85 deg.). After 72 hours, the samples were treated under the same conditions (23+/−2 C and 65+/−5% RH) and were secured to the tensile testing machine (an universal tensile testing machine manufactured by Shimadzu Corporation), and samples were peeled at a speed of 300 mm/min with an angle 180 degrees to the stainless steel plate.

Preparation of Examples

Materials used are listed in table 1 below:

TABLE 1
Non-halogen flame retardant adhesive composition

| Material | | Product name | Source |
|---|---|---|---|
| adhesive | Acrylic adhesive | 3M ™ product | 3M Company, St. |
| | polymer (40% solids | number | Paul, MN |
| | solution of 94/6 | 21331359477 | |
| | 2-ethyl hexyl acrylate/ | (not | |
| | acrylic acid copolymer | commercially | |
| | in ethyl acetate) | available) | |
| | Rosin Ester Tackifier | SYLVALITE | Arizona |
| | | RE80HP | Chemical, USA |
| | Bis-amide Crosslinker | 3M product | 3M Company, St. |
| | | number | Paul, MN |
| | | 11002603428 | |
| | | (not | |
| | | commercially | |
| | | available) | |
| Flame | Bis-phenol A bis | BDP | Goyen, Taiwan |
| retardant | (diphenyl phosphate) | | |
| composition | Melamine Cyanurate | MCA-300 | Green Yard, |
| | | | Taiwan |
| | Melamine | MPP-B | Green Yard, |
| | Pyrophosphate | | Taiwan |
| | Aluminum | OP935 | Clariant, |
| | Phosphinate Salt | | Germany |

Backing

| | | |
|---|---|---|
| Primer | 3M ™ P-93 | 3M Company, St. |
| | | Paul, MN |
| PET | TAIRILIN | Nan Ya, Taiwan |
| | BP25 | |
| Tissue | TA509 \grave{ } | Chung Rhy |
| | TA714 | Specialty Paper, |
| | | Taiwan |

### EXAMPLES AND COMPARATIVE EXAMPLES

To each of the examples and comparative examples, the ratio of adhesive and flame retardant composition as table 2 below were mixed using a laboratory-size high intensity mixer in the presence of a solvent (heptanes, ethyl acetate or a blend of both). The adhesive referred to the one with Acrylic adhesive polymer, tackifier and cross-linker, where in the ratio thereof was 2:1:0.1.

TABLE 2

| | Adhesive | Flame retardant composition (phr) | | | |
|---|---|---|---|---|---|
| Group | (phr) | BDP | MCA-300 | MPP-B | OP935 |
| Example 1 | 100 | 10 | 0 | 0 | 60 |
| Example 2 | 100 | 10 | 10 | 10 | 40 |
| Example 3 | 100 | 10 | 36.7 | 36.7 | 36.7 |
| Example 4 | 100 | 20 | 0 | 50 | 50 |
| Example 5 | 100 | 20 | 16.7 | 16.7 | 66.7 |
| Example 6 | 100 | 30 | 45 | 0 | 45 |
| Example 7 | 100 | 30 | 15 | 15 | 60 |
| Example 8 | 100 | 50 | 11.7 | 11.7 | 46.7 |
| Comparative | 100 | 10 | 43 | 43 | 43 |
| example 1 | | | | | |
| Comparative | 100 | 10 | 6.7 | 6.7 | 26.7 |
| example 2 | | | | | |
| Comparative | 100 | 0 | 11.7 | 46.7 | 11.7 |
| example 3 | | | | | |
| Comparative | 100 | 30 | 0 | 0 | 40 |
| example 4 | | | | | |
| Comparative | 100 | 70 | 0 | 0 | 50 |
| example 5 | | | | | |

The non-halogen flame retardant adhesive composition of each examples and adhesive of each comparative examples were directly applied to different material and thickness of baking treated with primer. The coating was using either a laboratory knife-coater to produce hand-spread samples or a pilot size coater (equipped with a knife-coater) to produce a continuous coated film with a nominal coating thickness of about 50 um. The UL94 VTM level and 180 degree peeling strength are provided as table 3 below:

TABLE 3

| | Group/Coating and Backing | | | |
|---|---|---|---|---|
| | | | | 180 |
| | | | | degree |
| | | | | peeling |
| | Double | Double | | strength |
| | coated on | coated on | Double coated | 72 hr |
| | 30 um tissue | 45 um tissue | on 25 um PET | (kg/in)* |
| Example 1 | UL94 VTM 0 | UL94 VTM 0 | UL94 VTM 0 | 2.261 |
| Example 2 | UL94 VTM 0 | UL94 VTM 0 | UL94 VTM 0 | 2.016 |
| Example 3 | UL94 VTM 0 | UL94 VTM 0 | UL94 VTM 0 | 1.213 |
| Example 4 | UL94 VTM 0 | UL94 VTM 0 | UL94 VTM 0 | 1.998 |
| Example 5 | UL94 VTM 0 | UL94 VTM 0 | UL94 VTM 0 | 1.217 |
| Example 6 | UL94 VTM 0 | UL94 VTM 0 | UL94 VTM 0 | 1.322 |
| Example 7 | UL94 VTM 0 | UL94 VTM 0 | UL94 VTM 0 | 1.416 |
| Example 8 | UL94 VTM 0 | UL94 VTM 0 | UL94 VTM 0 | 1.773 |
| Comparative | UL94 VTM 0 | UL94 VTM 0 | UL94 VTM 0 | 0.898 |
| example 1 | | | | |
| Comparative | Fail | Fail | UL94 VTM 1 | 2.101 |
| example 2 | | | | |
| Comparative | Fail | Fail | Fail | NA |
| example 3 | | | | |
| Comparative | Fail | Fail | UL94 VTM 2 | NA |
| example 4 | | | | |
| Comparative | NA | NA | NA | 0.653 |
| example 5 | | | | |

*The results were from group coated non-halogen flame retardant adhesive composition on both sides of tissue backing with average thickness 30um.

To those with skill in the art, it is to be understood that there is a positive correlation between the adhesion and tape thickness when the adhesive and coating thickness are the same. In addition, the adhesive will not immersed in PET backing, therefore, for non-halogen flame retardant adhesives double coated on either 45 um tissue backing or 25 um PET backing, the adhesions thereof were larger than that of 30 um tissue backing, and thus it is not redundantly listed here.

As shown in table 3, the adhesive tapes made by non-halogen flame retardant adhesive compositions of Examples 1 to Example 8 all showed outstanding adhesion and flame resistant capability, wherein the adhesion of each example was larger than 1.0 kg/in. As the adhesion of adhesive tape coated with adhesive of Comparative example 1 on 30 um tissue backing, the adhesion was less than 0.898 kg/in. Comparing Comparative example 1 and Example 3 (with 180 degree peeling strength 1.213 kg/in), it is to be understood that Comparative example 1 may not be good for adhering. Comparing Comparative example 2 and Example 2, though the adhesion were both above 1.0 kg/in, only 25 um PET backing coated with adhesive of Comparative example 2 can pass UL94 VTM 1 but the rest groups were all fail. Based on Comparative examples 3 to 5, when the ratio of bis-phenol A bis (diphenyl phosphate) was too high or too low, the adhesion or flame retardant capability were affected.

Table 4 showed the flame retardant capability of double coated adhesives tapes or single coated adhesive tapes coated with non-halogen flame retardant adhesive compositions from some examples on either 160 um PET backing or 25 um PET backing. The coating thickness of adhesives on single side is 50 um.

TABLE 4

| | Double coated | Singe coated on | Single coated |
|---|---|---|---|
| | on 160 um PET | 25 um PET | on 160 um PET |
| Example 1 | UL94 VTM 1 | UL94 VTM 0 | UL94 VTM 2 |
| Example 3 | UL94 VTM 1 | UL94 VTM 0 | UL94 VTM 2 |
| Example 4 | UL94 VTM 1 | UL94 VTM 0 | UL94 VTM 2 |
| Example 7 | UL94 VTM 1 | UL94 VTM 0 | UL94 VTM 2 |

As shown in table 4, when coated the non-halogen flame retardant adhesives from those examples on both sides of 160 um PET backing, the double coated adhesive tapes derived therefrom could all pass UL94 VTM 1. Applied the adhesives to one side of 25 um PET backing or 160 um PET backing to make single coated adhesive tapes, the adhesive tapes could UL94 VTM 0 and UL94 VTM 2, respectively.

To sum up, the non-halogen flame retardant adhesive of the current invention can make single or double coated adhesive tapes with thickness equal to or less than 260 um, and the adhesive tapes have good adhesion (with 180 degree peeling strength >1.0 Kg/in) and outstanding flame resistant capability (at least pass UL94 VTM 2). When the thickness of the adhesive tapes is equal to or less than 145 um, the flame retardant capability can achieve UL94 VTM 0 level.

Although the aforementioned detailed description contains many specific details for purposes of illustration, one with ordinary skill in the art will appreciate that many variations, changes, substitutions, and alterations to the details are within the scope of the invention as claimed. Accordingly, the invention described in the detailed description is set forth without imposing any limitations on the claimed invention. The proper scope of the invention should be determined by the following claims and their appropriate legal equivalents.

What is claimed is:

1. A non-halogen flame retardant adhesive composition, comprising:
an adhesive; and
a flame retardant composition comprising a phosphoric acid ester compound and a flame retardant material selected from one or more elements of a group consisting of melamine cyanurate, melamine pyrophosphate and phosphinate salt;
wherein the ratio of the adhesive and the flame retardant composition is in a range from 1:0.7 to 1:1.2, and the non-halogen flame retardant adhesive composition has 180 degree peeling strength above 1.0 kg/in based on ASTM-D3330 and achieves a UL 94 VTM flame resistance capability.

2. The composition of claim 1, wherein the phosphoric acid ester compound is bis-phenol A bis (diphenyl phosphate), and the ratio thereof to the flame retardant composition is no larger than 41.6%.

3. The composition of claim 1, wherein the phosphoric acid ester compound is bis-phenol A bis (diphenyl phosphate), and the ratio thereof to the flame retardant composition is in a range of 8.3%˜25.0%.

4. The composition of claim 1, wherein the ratio of the elements is 1:1 when the flame retardant material comprises two elements.

5. The composition of claim 1, wherein the flame retardant material comprises three elements; the ratio of melamine cyanurate to melamine pyrophosphate is approximately 1:1; and the ratio of melamine cyanurate to phosphinate salt is in the range of 1:1 to 1:4.

6. The composition of claim 1, wherein the phosphinate salt is Aluminum phosphinate.

7. The composition of claim 1, wherein the adhesive comprises an acrylic pressure sensitive adhesive.

8. An adhesive tape, comprising:
a backing; and
a non-halogen flame retardant adhesive composition comprising an adhesive and a flame retardant composition comprising a phosphoric acid ester compound and a flame retardant material selected from one or more elements of a group consisting of melamine Cyanurate, melamine pyrophosphate and phosphinate salt;
wherein the ratio of the adhesive and the flame retardant composition is in a range from 1:0.7 to 1:1.2, and the non-halogen flame retardant adhesive composition has 180 degree peeling strength above 1.0 kg/in based on ASTM-D3330 and achieves a UL 94 VTM flame resistance capability.

9. The adhesive tape of claim 8, wherein the backing is tissue or PET.

10. The adhesive tape of claim 8, wherein the thickness of the backing is no larger than 160 microns.

11. The adhesive tape of claim 10, wherein the thickness of the backing is in a range of 25 microns to 45 microns.

12. The adhesive tape of claim 8, wherein the thickness of the non-halogen flame retardant adhesive composition is in a range of 25-75 microns.

13. The adhesive tape of claim 8, wherein the phosphoric acid ester compound is bis-phenol A bis (diphenyl phosphate), and the ratio thereof to the flame retardant composition is no larger than 41.6%.

14. The adhesive tape of claim 13, wherein the phosphoric acid ester compound is bis-phenol A bis (diphenyl phosphate), and the ratio thereof to the flame retardant composition is in a range of 8.3%˜25.0%.

15. The adhesive tape of claim 8, wherein the ratio of the elements is 1:1 when the flame retardant material comprises two elements.

16. The adhesive tape of claim 8, wherein the flame retardant material comprises three elements; the ratio of melamine Cyanurate to melamine pyrophosphate is approximately 1:1; and the ratio of melamine cyanurate to phosphinate salt is in the range of 1:1 to 1:4.

17. The adhesive tape of claim 8, wherein the phosphinate salt is aluminum phosphinate.

18. The adhesive tape of claim 8, wherein the adhesive comprises an acrylic pressure sensitive adhesive.
